(19) United States
(12) Patent Application Publication
(10) Pub. No.: US 2010/0170211 A1
(43) Pub. Date: Jul. 8, 2010

(54) Intake Air Cleaner

(75) Inventors: Charles Vaillant, Kalamazoo, MI (US); Ronald Randall, Athens, MI (US)

Correspondence Address: Mann+Hummel GMBH;Department VR-P, Hindenburgstr. 45, Ludwigsburg, 71638, DE

(73) Assignee: MANN+HUMMEL GMBH, Ludwigsburg (DE)

(21) Appl. No.: 12/595,299

(22) PCT Filed: Mar. 31, 2008
(86) PCT No.: PCT/EP08/53832

§ 371 Date: Feb. 3, 2010

Related U.S. Application Data
(60) Provisional application No. 60/907,625, filed on Apr. 11, 2007.

(51) Int. Cl. B01D 46/52

(52) U.S. Cl. 55/500

(57) ABSTRACT

An intake air cleaner element for an internal combustion engine is described. It consists of a winding filter, the winding filter being flown through axially and featuring in the area of one front end at the circumference a sealing and/or fastening element. In the center of the winding filter an end-to-end cavity is provided. At least at one front end of the winding filter one autonomous cap is located for closing the cavity.

### TECHNICAL DOMAIN

The invention relates to an intake air cleaner according to the preamble of the independent claim 1.

### PRIOR ART

An air cleaner can be taken from U.S. Pat. No. 6,322,602 B2 which features an axially through-flowing filter element in cylindrically shaped filter housing. The receptacle for accepting the filter in the filter housing is to be closed at an axial front end in the area of the inflow side of the filter by a housing cover which is disengaged when changing the filter element, whereupon the filter element can be axially removed from the receptacle and replaced by a new filter element.

Furthermore, a filter element is known from the U.S. Pat. No. 6,852,141 which is composed of a winding filter. This winding filter features a supporting element located at the front end. This supporting element has a center mandril, and in turn the mandril is equipped with a handle at the side opposite to the supporting element. This handle allows the operator to pull the filter element out of the housing, provided that the filter element shall be changed. One disadvantage of the known system is that the mandril must be introduced into the winding filter when the filter element is manufactured and the handle must be fastened at the mandril, for example with a screwed fastening.

The task of the invention is to create a filter of a simple structure with a filter element, the filter element itself featuring a sufficient stability without additional reinforcing elements.

This task is resolved through the characteristic features of the independent claim 1.

### DISCLOSURE OF THE INVENTION

The principal advantage of the invention is the fact that with an autonomous cap the center of a winding filter can be closed easily. In this respect, the diameter's size of the open center of the winding filter is irrelevant, however, the size of the plug needs to be corresponding with the aperture, even oval apertures can be closed without problem by means of a corresponding cap.

According to a further development, an autonomous cap is located at both front ends of the winding filter. It is not necessary to fill the existing cavity between both caps. Usually, the plug is used on the dirty-air side. The clean-air side can be left open if it is sealed on the other side.

According to prior art, the whole cavity was often filled with plastic material. This entailed considerable additional costs. It is preferred to use hot-melt or PUR.

The cap itself can be made either of metal or plastic or of any other material and it is fastened at the winding filter by means of a glued joint.

According to a further embodiment of the invention, the cap features a tapered shape. According to a further development, it is flush with the surface at the front end of the winding filter. The use of holes or slots in the plug is advantageous to create a mechanical lock with the glue.

According to yet another embodiment of the invention, the air cleaner element is to be integrated into an intake filter system, wherein this filter system consists of one housing with at least two housing parts, and wherein this housing contains the winding filter.

The housing has a concentric shape and features a dirty air inlet and a dirty air outlet. In a further development, both housing parts are connected by means of snap-on or clamping connections. It is also possible to equip the housing with a bayonet connection.

These and other features of the invention, in addition to being set forth in the claims, are also disclosed in the specification and in the drawings.

### BRIEF DESCRIPTION OF THE DRAWINGS

The invention will be described hereinafter by means of drawings. It shows

FIG. 1 the cross-sectional schematic view of an intake filter,

FIGS. 2a, b ,c different autonomous caps and

FIG. 3 an intake filter system.

### EMBODIMENT(S) OF THE INVENTION

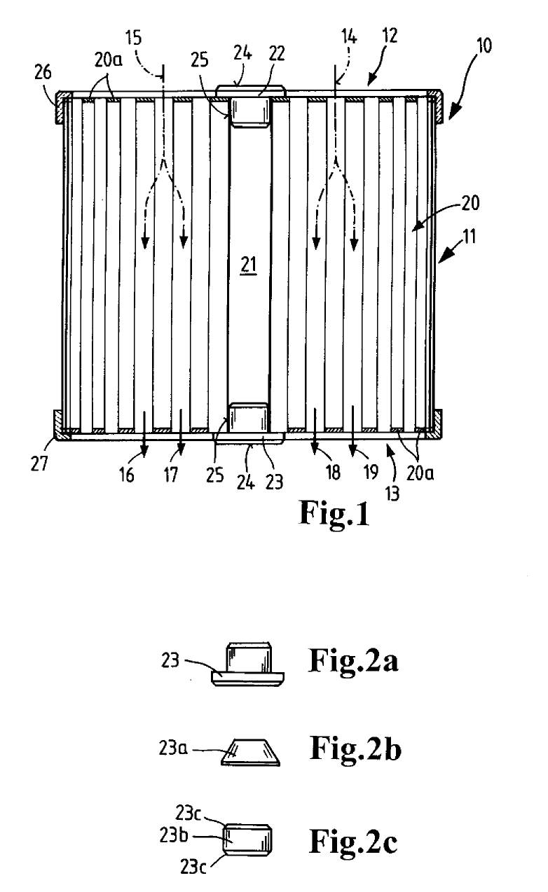

FIG. 1 shows in a cross-sectional view an intake filter element 10, consisting of a winding element 11 which has a concentric structure and features an inflow side 12 as well as an outflow side 13. The air to be cleaned flows according to the arrows 14, 15 into the channels opened at the inflow side, flows alongside the channels through the filter medium and exits according to the arrows 16, 17, 18, 19. These arrows are only representative for a plurality of through-flow apertures. Usually, a winding element 11 is wound onto a mandril during its manufacture, at the same time the channels 20 are closed at the inflow side and the outflow side by means of glue fillets 20a. After the manufacture of the winding element, this element is pulled off the mandril, and in the interior remains an end-to-end aperture 21. Sealing said aperture 21 could also be effected either with a glue or a plastic material. Advantageously, this is realized by two autonomous caps 22, 23 which are glued at the front end into the winding element. Each of these caps features a covering surface 24 which extends to a small part over the channels, thus forming a defined stop. A centering shoulder 25 extends into the aperture 21. This centering shoulder is equipped with the necessary glue for gluing the cap. Furthermore, in FIG. 1 is provided a circumferential sealing system 26 as well as another stabilization system 27. The filter element is then fastened and sealed in a housing (not represented here) by means of the sealing and stabilization systems.

FIG. 2a shows an autonomous cap 23 with the features already described in FIG. 1.

FIG. 2b shows a cap 23a in a tapered shape. It can be flush with the surface at the front end of a winding element.

FIG. 2c shows a cylindrically shaped cap 23b with chamfered front ends 23c. This one, too, can be embedded into a winding element flush with the surface.

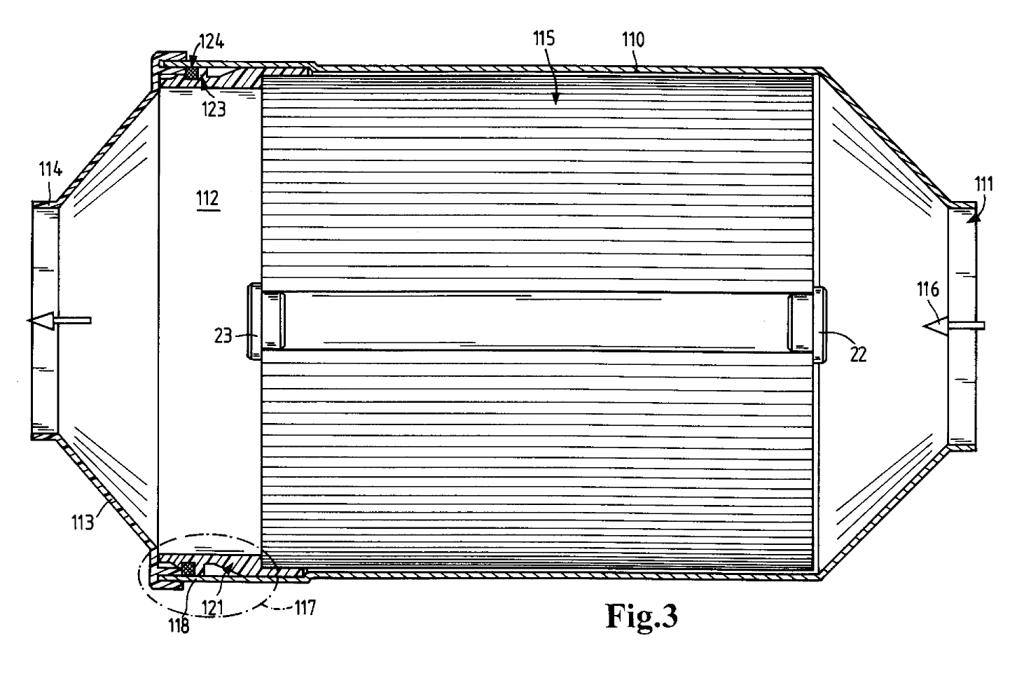

The filter system according to FIG. 3 consists of a housing 110 which has a substantially concentric, oval or elliptic shape. This housing 110 features a dirty air inlet 111 which is coupled with a dirty air intake port not shown here. A housing cover 113 is provided at the clean air side 112, the housing cover being also provided with a connection piece 114 to which a clean air duct can be connected. Inside the housing 110 is a filter element 115. This is an element already described in FIG. 1. The element is flown through according to arrow 116, the cleaned air exits the filter element axially at the clean air side 112.

The fastening of the filter element 115 as well as the connection between the housing 110 and the housing cover 113 is realized in the area of connection 117 which extends over the entire circumference of the filter system.

The fastening ring 121 is provided with a surrounding torus 123 which supports a profile packing 124. The profile packing abuts the edge 118.

1. Intake air cleaner element for an internal combustion engine, comprising:
a winding filter configured for axial flow;
wherein said winding filter has axially aligned flow ends consisting of an inflow side and an outflow side;
wherein an end to end cavity is provided in a center of the winding filter extending between and opening through at least one of said flow ends;
at least one autonomous cap closing off said cavity on at least one of said flow ends; and
at least one of a circumferential sealing element or a circumferential stabilizing element circumferentially arranged proximate to at least one of said flow ends.

2. Intake air cleaner according to claim 1, characterized in that at an opposing flow end another autonomous cap is located.

3. (canceled)

4. Intake air cleaner according to claim 2, characterized in that the cap is connected with the winding filter by means of a glued joint;
wherein said cap includes a centering shoulder received into said cavity; and
wherein said cap includes an outward facing covering surface which has a slightly larger diameter than the centering shoulder.

5. Intake air cleaner according to claim 4, characterized in that the cap features a tapered shape.

6. Intake air cleaner according to claim 4, characterized in that the cap is located flush with the surface at the front end.

7. Intake filter system for a filter element according to claim 4, comprising a housing with at least two housing parts, the housing being separable advantageously in a fastening area of the filter element, and the sealing element causing a separation between dirty air side and clean air side of said housing.

8. Intake filter system according to claim 7, characterized in that the connection of the housing parts is ensured by means of snap-on or clamping connections.

9. Intake filter system according to claim 8, characterized in that the housing for fastening a clean air pipe at the clean air side is provided with a connection piece, the transition between filter element and connection piece being shaped essentially conically.
